(19) United States
(12) Patent Application Publication
(10) Pub. No.: US 2025/0278629 A1
(43) Pub. Date: Sep. 4, 2025

(54) EFFICIENT ATTENTION USING SOFT MASKING AND SOFT CHANNEL PRUNING

(71) Applicant: QUALCOMM Technologies, Inc., San Diego, CA (US)

(72) Inventors: Winfried VAN DEN DOOL, Utrecht (NL); Yuki ASANO, Amsterdam (NL); Max WELLING, Bussum (NL); Tijmen Pieter Frederik BLANKEVOORT, Amsterdam (NL)

(21) Appl. No.: 18/592,193

(22) Filed: Feb. 29, 2024

(51) Int. Cl. G06N 3/082; G06N 3/045

(52) U.S. Cl. CPC G06N 3/082; G06N 3/045

(57) ABSTRACT

A processor-implemented method includes configuring a transformer model having multiple attention heads. Each attention head has a set of architecture parameters and weight parameters. The set of architecture parameters are determined for each attention head based on using a soft pruning technique according to a fixed training budget. In turn, the transformer model generates an inference based on the set architecture parameters and an input.

### FIELD OF THE DISCLOSURE

Aspects of the present disclosure generally relate to machine learning and more particularly to attention using soft masking and pruning.

### BACKGROUND

Artificial neural networks may comprise interconnected groups of artificial neurons (e.g., neuron models). The artificial neural network (ANN) may be a computational device or be represented as a method to be performed by a computational device. ANNs have numerous applications. In particular, these neural network architectures are used in various technologies, such as image recognition, speech recognition, acoustic scene classification, keyword spotting, autonomous driving, and other classification tasks.

ANN models may process inputs of varying lengths for the different applications. As the input size increases, the computational complexity increases quadratically and may limit the practicality of the model. Attention mechanisms have been proposed to reduce the computational complexity. Attention mechanisms may be designed to mimic human cognitive attention. For instance, given an input (e.g., a sentence), an attention mechanism may be designed to focus the network on more salient portions of the input rather than the entire input. However, attention operations may also be computationally expensive with cost on the order of O (N²d) for N nodes and d channels, thus making using attention mechanisms challenging.

### SUMMARY

The present disclosure is set forth in the independent claims, respectively. Some aspects of the disclosure are described in the dependent claims.

In some aspects of the present disclosure, a processor-implemented method includes receiving a transformer model including multiple attention heads. Each attention head has a set of architecture parameters and weight parameters. The processor-implemented method also includes determining the set of architecture parameters for each attention head based on a soft pruning technique according to a fixed training budget. The processor-implemented method further includes operating the transformer model to generate an inference based on the architecture parameters and an input.

Various aspects of the present disclosure are directed to an apparatus including means for receiving a transformer model including multiple attention heads. Each attention head has a set of architecture parameters and weight parameters. The apparatus also includes means for determining the set of architecture parameters for each attention head based on a soft pruning technique according to a fixed training budget. The apparatus further includes means for operating the transformer model to generate an inference based on the architecture parameters and an input.

Some aspects of the present disclosure are directed to an apparatus having at least one memory and one or more processors coupled to the at least one memory. The processor(s) is configured to receive a transformer model including multiple attention heads. Each attention head has a set of architecture parameters and weight parameters. The processor(s) is also configured to determine the set of architecture parameters for each attention head based on a soft pruning technique according to a fixed training budget. The processor(s) is further configured to operate the transformer model to generate an inference based on the architecture parameters and an input.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 2D is a diagram illustrating an exemplary deep convolutional network (DCN) in accordance with various aspects of the present disclosure.

FIGS. 3A and 3B are a block diagrams illustrating a vision-based transformer and a transformer encoder, in accordance with various aspects of the present disclosure.

FIG. 4 is a block diagram illustrating an exemplary software architecture that may modularize artificial intelligence (AI) functions, in accordance with aspects of the present disclosure.

FIG. 5 is a diagram illustrating various examples of attention neighborhoods, in accordance with various aspects of the present disclosure.

FIG. 6A-C are diagrams illustrating a training sequence for determining architecture parameters for attention heads, in accordance with various aspects of the present disclosure.

FIG. 7 is a flow diagram illustrating a processor-implemented method for configuring attention mechanisms of transformer models using soft masking and soft channel pruning, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Recently, transformer architectures have shown improvement in language modeling and natural language processing (NLP) tasks. Based on transformer architectures such as (but not limited to) bi-directional encoder representations from transformers (BERT), robustly optimized BERT approach (RoBERTa), XLNet, Transformer-XL, and the generative pre-trained transformer (GPT) family of transformers (e.g., GPT-2, GPT-3, GPT-4, etc.), language models may be pre-trained with a large corpora of unlabeled text. Accordingly, such transformer architectures have become popular building blocks in conventional NLP pipelines, as well as in other areas such as computer vision and audio processing.

Vision-based transformers (e.g., vision transformers (ViTs)) are widely used for computer vision tasks such as classification, detection, segmentation, and depth estimation, for example. Vision transformers apply transformer architectures directly to images. Rather than process tokens including portions (words) of text or audio sequences, vision transformers split an image into patches and treat the patches as tokens in an NLP application.

The transformer architectures may rely on attention mechanisms to enable the respective artificial neural network models to selectively focus on specific parts of an input sequence. In doing so, an attention mechanism may assign varying degrees of importance to different elements of the input sequence, which may improve the model's ability to capture relevant information and make more informed predictions.

Attention mechanisms may be applied globally or locally. A global attention mechanism may operate on an entire input sequence and may assign weights to different portions of the input sequence. The global attention mechanism may calculate an attention score for each portion of the input sequence to enable an artificial neural network (ANN) model to focus on more relevant parts of the input sequence.

Attention operations may be costly with complexity of O(N²d) for N nodes and d channels. Getting the attention operations to run in linear time is an increasingly popular problem. Some conventional approaches may use masks that prevent all tokens from attending each other, to reduce the O(N²d) complexity of the standard self-attention. That is, such conventional approaches may employ a local attention mechanism that may limit the scope of attention to a specific region of the input sequence. For instance, a local attention mechanism may limit the scope to a neighborhood around a current node. As a result, the computational complexity may be reduced to O(NdR), where R is the region size. In such conventional approaches, only tokens that are close together, in a predefined neighborhood or using a predefined distance (measure), may be allowed to communicate (e.g., their attention interaction is computed).

As such, the self-attention complexity may be linear in the number of tokens and the size of the neighborhoods used, which may be much smaller than N. The reduction in complexity may serve as a tradeoff and result in in a loss in expressivity. Expressivity may refer to the degree to which the functions of a neural network domain may be represented by classes of the neural network model. Balancing the trade-off between expressivity and efficiency may be challenging.

To address these and other issues, aspects of the present disclosure are directed to multi-neighborhood attention in which different attention heads may be directed to different neighborhood sizes. In some aspects, the attention heads may be fully diversified across attention layers. That is, the attention heads across attention layers may have different neighborhood sizes as well as different numbers of channels.

Particular aspects of the subject matter described in this disclosure can be implemented to realize one or more of the following potential advantages. In some examples, the described techniques (e.g., determining the set of architecture parameters for each attention head based on using a soft pruning technique according to a fixed training budget) may beneficially reduce computational complexity while reducing, and in some aspects minimizing, the loss in expressivity.

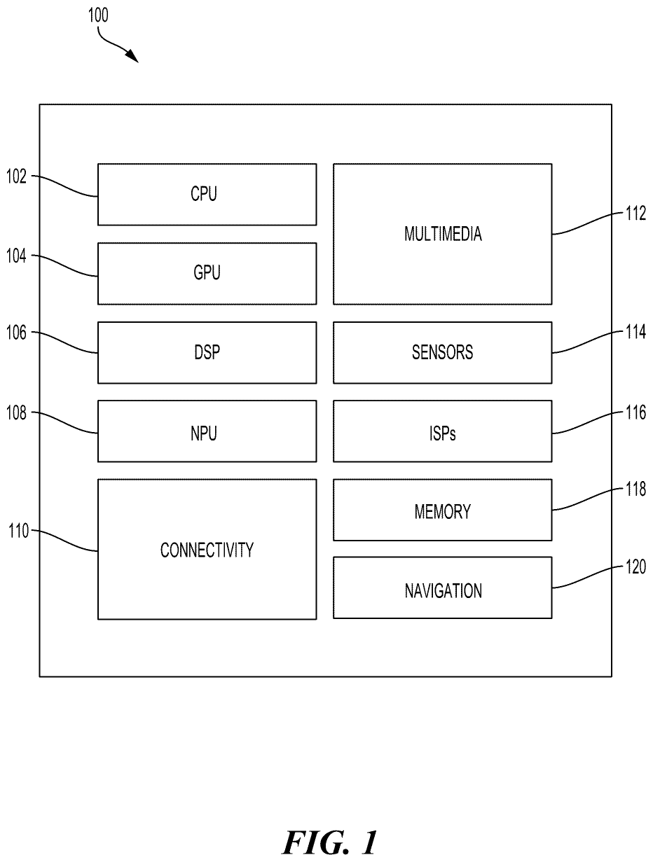

FIG. 1 illustrates an example implementation of a system-on-a-chip (SOC) 100, which may include a central processing unit (CPU) 102 or a multi-core CPU configured for attention using soft masking and pruning. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive a transformer model including multiple attention heads. Each attention head has a set of architecture parameters and weight parameters. The instructions loaded into the general-purpose processor 102 may also include code to determine the set of architecture parameters for each attention head based on a soft pruning technique according to a fixed training budget. The instructions loaded into the general-purpose processor 102 may further include code to operate the transformer model to generate an inference based on the architecture parameters and an input.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

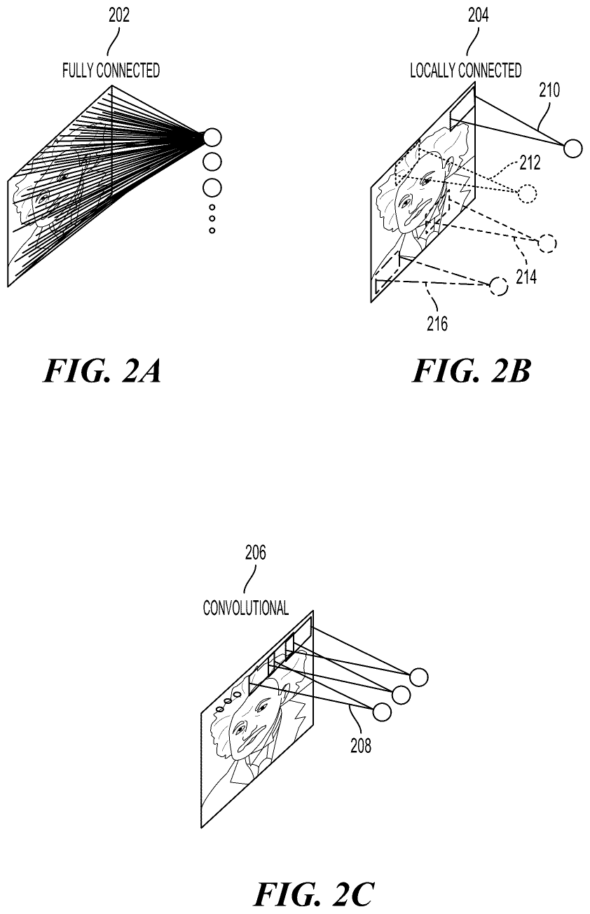

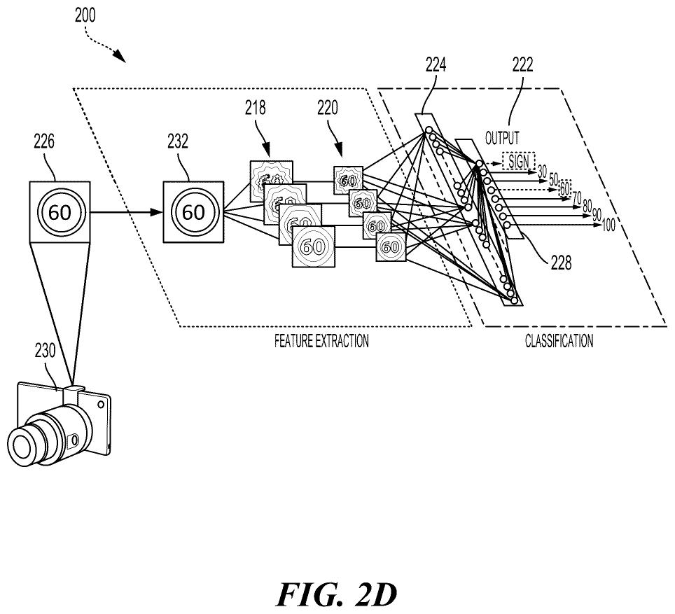

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

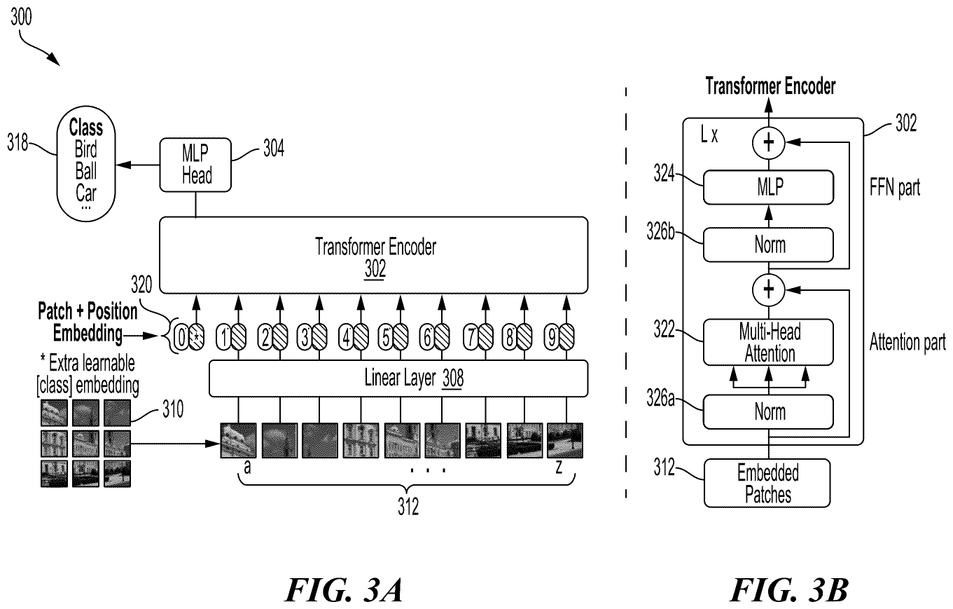

FIGS. 3A and 3B are a block diagrams illustrating a vision-based transformer 300 and a transformer encoder 302, in accordance with various aspects of the present disclosure. Referring to FIG. 3A, the vision-based transformer 300 includes the transformer encoder 302 and a multilayer perceptron (MLP) head 304.

The vision-based transformer 300 may operate in a manner similar to transformers in natural language processing applications. That is, the vision-based transformer 300 may split an input image 310 (shown split into patches of pixels) into multiple patches 312a-z (collectively referred to as image patches 312) that may be treated as tokens (e.g., words). The image patches 312 are supplied to a linear layer 308, which generates a sequence of linear embeddings. Positional embeddings may be added to the linear embeddings to form patch and positional embeddings 320, which may be provided to the conventional transformer encoder 302.

The transformer encoder 302 processes the patch and positional embeddings 320 to determine relationships between the patch and positional embeddings 320 and generates an output. The output is provided to the MLP head 304, which generates a classification 318 for the input image 310.

FIG. 3B shows an expanded view of the transformer encoder 302. The transformer encoder 302 may include alternating layers of multi-head attention blocks 322 and MLP blocks 324. A layer norm block 326 (e.g., 326a, 326b) may be applied before every block of the conventional transformer encoder 302. The multi-head attention blocks 322 and MLP blocks 324 may each include a residual connection.

In various aspects, the attention blocks (e.g., 322) may be configured according to the multi-head attention approach using soft masking and pruning.

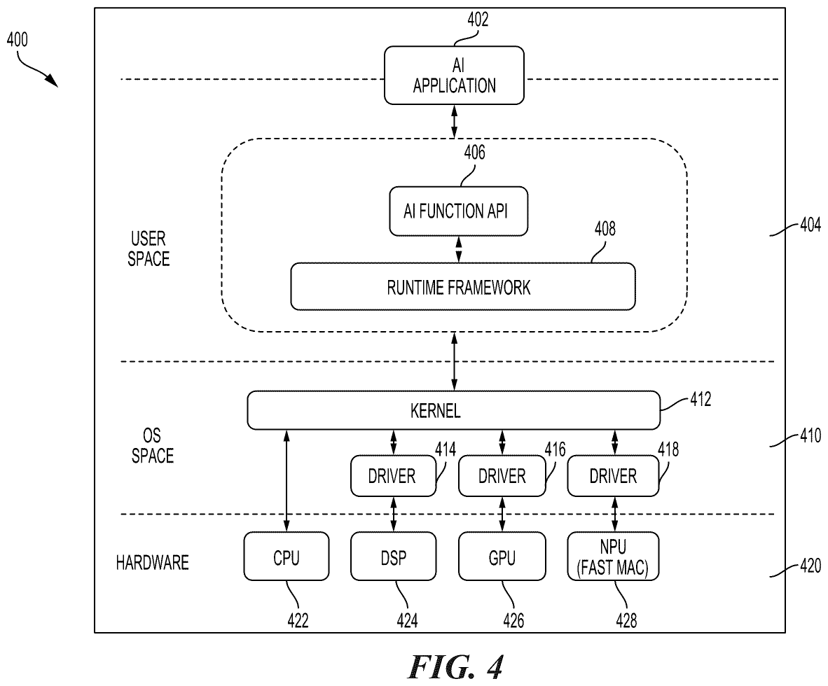

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support multi-neighborhood attention for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an Al function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to multi-neighborhood attention using soft pruning techniques and/or soft masking, for example.

In accordance with various aspects of the present disclosure, an artificial neural network may be received. The artificial neural network (ANN) may for instance comprise a transformer model (e.g., 302 of FIG. 3B). The transformer model may include multiple attention heads (e.g., 322). Each attention head of the multi-head attention can look at a different neighborhood size or may have architecture parameters that vary in comparison to other attention heads. For each attention head i, a neighborhood may be defined by δⁱ for a region size Rⁱ, where δ represents a distance. Each attention head may also have query and key matrices Qⁱ and Kⁱ, each of which may have d_{qk}ⁱ rows, where d corresponds to a number of channels. Further, each attention head may have a value matrix Vⁱ with dᵥⁱ rows. As a result, the computational complexity may be given by O(NRⁱ(d_{qk}ⁱ+dᵥⁱ)).

In some aspects, groups of attention heads may be combined such that operations for a bundle of attention heads may be sent to a GPU or other processing unit, for instance, instead of the operations of a single attention head. Given a number of attention heads Hⁱ, the complexity Cⁱ for each bundle of attention heads may be on the order of O (NHⁱRⁱ(d_{qk}ⁱ+dᵥⁱ)). The total network cost for the attention operations may be given by ΣᵢCⁱ.

To train the architecture parameters that define the bundles, the first channels d may be most important. Then soft pruning may be applied with annealing during training. That is, the architecture parameters may be normalized using a total fixed budget, which may for instance be set to the total network cost for the attention operations.

Soft pruning from a predetermined “full” parameter=selecting from a mixture of experts that share parameters (e.g., expert₁₀ may use only the first 10 channels, and expert₁₂₀ may use the first 120 channels).

Parameter sharing may reduce behavioral inconsistency. If experts have different behavior (e.g., parameters), a combination of them forms a richer representation and may thus likely be better. As a result, the direction of improvement is not towards the most expensive expert, but towards some weighted average (that is eventually unattainable, when annealing towards a single choice).

Naive implementation of annealing can lead to collapse. Channels that are not selected are not updated. One potential solution involves first training regular parameters (e.g., weights), then training architecture parameters (e.g., attention heads, region size or number of channels). However, separate training of regular parameters and architecture parameters prevents training of some network layers, thus pruning of such network layers. Moreover, some network layers may appear to use many channels, but the number of channels may in fact be further reduced if other network layers correct for the layer evaluated. Thus, in some aspects, multiple architectures may be trained simultaneously while maintaining consistent behavior among possible attention bundles because of the parameter sharing.

In various aspects, a soft mask may be integrated into masked self-attention, which describes a neighborhood or distance threshold, and for which the attention between tokens may not be fully masked but may be computed using fewer resources than usual. As such, the categories of regions may include a hard masked region that is not included, a soft masked region that is included but computed using fewer computational resources, and a non-masked region that is computed in an ordinary way. The inclusion of the soft mask may enable balancing the expressivity and complexity (e.g., efficiency) trade-off more precisely.

Attention (e.g., attention score) between two tokens may be computed using fewer computational resources by pruning channels, both in the computation of the attention matrix as well as the attention output. The parameters that define the soft and hard masked regions (e.g., architecture parameters) may be trainable parameters, and the number of channels used may depend on such parameters in such a way that the computational budget is fixed. Soft pruning may be applied during training, to ensure differentiability. Then, an annealing process may be performed in the direction of hard pruning locations at the end of training, leading to efficient inference. This is because, rather than a weighted average as in a conventional mixture of experts approach, the annealing process tends toward identifying a single expert (e.g., set of architecture parameters) for the bundle of attention heads.

Given Q, K, V∈ [symbol] ^{N×d} represent query, key, and value matrices respectively, where N is the sequence length and d is the attention head dimension. An attention output Y∈ [symbol] ^{N×d} may be given by the following operations:

$$A = \frac{Q {K}^{T}}{\sqrt{d}} \qquad ( 1 )$$

$$S = σ ( A )$$

$$Y = SV ,$$

where A represents the attention matrix and σ is a softmax function that is applied row-wise. For clarity, the attention matrix may be expressed as:

$${A}_{i j} = \frac{1}{\sqrt{d}} {\sum }_{t = 1}^{d} {Q}_{it} {K}_{jt} \qquad ( 2 )$$

$${S}_{i j} = {σ ( {A}_{i} )}_{j}$$

$${Y}_{it} = {\sum }_{j = 1}^{N} {S}_{ij} {V}_{jt} .$$

Ignoring the sigmoid operation, the complexity of both matrix multiplications may be on the order of O(N²d) (The first consists of N² entries of d multiplications, the second consists of Nd entries of N multiplications.)

Patches or neighborhoods that are farther away from each other may not share information. The distance between patch i and j may be given by δ(i, j). Avoiding computing the attention between i and j, which is the inner product Qᵢ·Kⱼ, if δ(i, j)≥δ₀, Equation 2 may be rewritten as:

$${A}_{i j} = \{ \frac{1}{{\sqrt{d}}_{- ∞ else ,}} {\sum }_{t = 1}^{d} {Q}_{it} {K}_{jt} if δ ( i , j ) < {δ}_{0} \qquad ( 3 )$$

$${S}_{i j} = {σ ( {A}_{i} )}_{j}$$

$${Y}_{it} = {\sum }_{j = 1}^{N} {𝕝}_{δ ( i , j ) < {δ}_{0}} {S}_{ij} {V}_{jt} .$$

Regions (e.g., neighborhoods) may be defined as follows:

$${R}_{i} ( {δ}_{0} ) = \{ j : δ ( i , j ) < {δ}_{0} \} , \qquad ( 4 )$$

$$𝒩 ( {δ}_{0} ) = {max}_{i} \vert {R}_{i} ( {δ}_{0} ) \vert , \qquad ( 5 )$$

where Rᵢ represents the size of a region, within distance δ₀ of patch i, and [symbol] represents a maximal size that such a region can attain, respectively. As such, the complexity may be greatly reduced. The first matrix multiplication may involve N [symbol] (δ₀) entries of d multiplications, and the second matrix multiplication may involve [symbol] d entries of [symbol] (δ₀) multiplications, making the computational complexity for each operation O(N [symbol] (δ₀)d). When [symbol] (δ₀)<<N, the reduction may be substantial.

Given M attention heads, with the sum of their dimensions equal to Md=D, the complexity is given by O(N²D), or O(N [symbol] (δ₀)d) if using a local mask defined by distance δ₀.

In multi-head attention, different attention heads may learn different tasks. In various aspects of the present disclosure, each attention head may have a different neighborhood size as well to attend to. However, different neighborhoods may have different learning goals and may vary in complexity. As such, more or less channels than a default number of channels d_{qk} or dᵥ may be used. In addition, different neighborhoods may have different computational cost. For example, having many channels on a small neighborhood may not be overly burdensome, but having many channels on a large neighborhood may add a significant computational cost. In the context of multi-head attention and varying neighborhoods, one extension may be to fully diversify the attention heads. In other words, an attention head h may have the following specific parameters:
A neighborhood defined by δ^{h} (producing a region size R^{h}),
Query and Key matrices Q^{h}, K^{h} containing d_{qk}^{h} rows, and
A value matrix V^{h} which has dᵥ^{h} rows.

The contribution to the inference complexity of a single attention head may be given by O(NR^{h}(d_{qk}^{h}+dᵥ^{h}).

In practice, it may be convenient to combine computation operations of multiple attention heads having the same parameters (e.g., having similar neighborhood sizes and/or channel numbers) into a bundle. The bundle may be provided a processor such as the GPU, for instance, as a single compute request instead of sending computation operations for each attention head to the processor (e.g., GPU) separately. In some aspects, setups may be employed, wherein each setup includes a number representing how many attention heads as well as a (shared) hyperparameters of the attention heads.

Diversifying the hyperparameters used in each attention head, even when bundling heads in setups as in multi-setup attention, may result in a very large hyperparameter space. To determine an architecture, and in some aspects, an optimal architecture, gradient descent methods may be used, and thus the hyperparameters may be differentiable.

During training, an attention head or setup architecture parameter (e.g., how many channels are used, or what neighborhood size is used) may not be enforced as a hard constraint because the hard constraint would not be differentiable, making gradient descent methods inapplicable. Instead, soft pruning may be applied. In soft pruning, channels may be removed only partially by multiplication with a factor in the range [0, 1]. The soft pruning approach may, for example be implemented by framing the problem as a Mixture-of-Experts situation, in which the expert distribution may be learned.

In various aspects, a certain submodule may be expressed as an expert E such that:

$$y = E ( x ; p ) , \qquad ( 6 )$$

where the general learnable weights of the submodule are omitted, focusing on the architecture parameter p (e.g., a neighborhood size or a number of channels). The architecture parameter p may be constrained to lie in a given range [pmin, pmax]. For instance, to investigate kernel sizes 3, 5, and 7 for neighborhood attention, the region size is in the range [9, 49].

A vector of valid parameters, pvalid may be defined, in this example, as [9, 25, 49] as neighborhood attention may only be implemented for odd kernel sizes (e.g., 3, 5 and 7). If p represents the number of channels used for the value matrix V, for example, and the range [pmin, pmax]=[16, 48], then the vector of valid parameters pvalid=[16, 18, 20, . . . , 46, 48], as the GPU implementation of neighborhood attention may use even channel numbers.

A categorical distribution parameterized may be defined by q∈[pₘₐₓ, pₘᵢₙ] as follows:

$$P ( p \vert q ; T ) ∝ Exp ( - {( \frac{p - q}{( {p}_{{max}^{-}} {p}_{min} ) \cdot T} )}^{2} ) , \qquad ( 7 )$$

where p∈p_{valid} corresponds to a candidate expert, q represents a learnable parameter and T represents a temperature variable. The distribution may be centered around q, meaning that the variable q may precisely corresponds to an inference value that is targeted during training. The output of the certain submodule during training may then be given by the expected value:

$${\sum }_{p ∈ {p}_{valid}} {E}_{p} ( x ) \cdot P ( p \vert q ; T ) . \qquad ( 8 )$$

During training, the parameter q may be learned as a regular parameter (e.g., weight) and an annealing schedule may be applied that decreases the temperature T. In doing so the distribution may be spread out in the beginning of training, then later may become more focused in a single point near the end of the training cycle. In some aspects, in the limit as T→0, the distribution may become one-hot-encoded, such that the training may produce a single valid value of p∈p_{valid}. For practical reasons, to enable each distribution parameter q to have similar training behavior, q may be set as follows:

$$q = {p}_{min} + {π}_{q} \cdot ( {p}_{max} - {p}_{min} ) , \qquad ( 9 )$$

where π_{q}∈[0,1] represents a pruning parameter that determines the extent to which channels are pruned away from the maximum value pₘₐₓ. If p and q refer to numbers of channels, then the mixture of experts corresponds to soft pruning of channels. In this context expert E(.;p) may correspond to keeping all channels up to and including the p-th channel. For a given channel index j, the channel may be considered pruned if j>q. However, for sufficiently high temperature T, the value at index j may not be completely set to 0, as some Experts with p≥j but not p>>q may have a nonzero contribution to the submodule output 8.

If certain experts are not used during training, the corresponding regular weights may not be updated. As a result, the distribution architecture parameter may avoid such experts and may lead to a cascading effect in which certain parts of the network “die out”. One solution may be to first train the regular weights, and then apply a fine-tuning phase for the architecture parameters.

When a network has the ability to choose between different experts, the network may prefer to use both experts for greater representational power. However, the behavior among experts should consistent. Consider two experts that produce similar outputs, but a first expert is slightly noisy and the second expert is slightly more precise (although more expensive). If the two experts have consistent behavior, there may be no added value for the network to use both experts because doing so does not result in larger representational power.

However, training the weight parameters before the architecture parameters are trained may be suboptimal. Freezing the weights parameters during the final architecture fine-tuning phase may prevent experts in later network layers from correcting mistakes made by experts elsewhere or from filling gaps that may be left when smaller experts are selected instead of more expensive but better experts.

During the fine-tuning phase, an expert in the first layer of the network may be very expensive, but computation costs may be reduced if the weights of some later experts are adjusted for some missing signals. To address the issue, nested expert dropout may be implemented. For a given module a list of experts may be defined in such a way that the experts share weights. In particular, the parameters for the experts may form an increasing subset list. For example, the parameters of expert i, Wᵢ may be included in the parameters of expert j, Wⱼ, for an expert j that is larger (or more expensive) than expert i. As such, with each of the experts defined by the number of channels used, the expert that uses n channels may share all weights corresponding to the first m<n channels with the expert that uses m<n channels.

For a given attention module, a set of N possible experts may be provided. During the training of the weights (as opposed to architecture parameters), a random number in {1, . . . , N} may be selected in each forward step, representing the expert used for that forward step. In the current context, the training strategy may correspond to a nested dropout for the channels. That is, a random slice from each activation vector may be retained while the remainder of the activation vector may be dropped out (as opposed to conventional dropout where activations that are dropped are chosen at random independently).

This training strategy may enable the sharing of parameters (e.g., channels) achieving behavioral consistency among experts. That is, there may be no incentive for the network during the fine-tuning phase to use a mixture of two experts for a larger representational power. In addition, during training, smaller experts may be selected in one part of the network, and larger experts may be selected elsewhere in the network to cover for a lack of signal, for instance. Hence, experts may be prepared for the error correction in the fine-tuning phase. Finally, as the training phase begins with all experts having a positive chance of being selected, and helped by the parameter-sharing among experts, to reduce collapse issues with respect to experts. Having trained an architecture using the nested-dropout approach may render the training to be elastic, in the sense that different combinations and slices of weights may be used during inference.

Without any constraints on the architecture parameters q, or πq from equation 9, the network may aim for πq=1, selecting the most expensive experts. However, in some aspects, a budget ß, representing the total computational cost of the network in giga multiply accumulate operations per second (GMACS) may be employed. As the loss regularization approach may be difficult to optimize, a budget may be such that each πq is multiplied by a normalization constant x, such that the resulting budget is fixed during training.

Given that there are M attention modules in the network, and for each m∈{1, . . . , M} the relevant architecture parameters in nm may be combined, thus making πm a vector that includes all pruning parameters from module m. The cost of module m may be given by Cₘ(πₘ). For example, the neighborhood attention operation in Equation 3 may have a cost given by:

$$C ( {d}_{q k} , {d}_{v} , R ) = ( 2 N + R ) \cdot ( {d}_{q k} + {d}_{v} ) \qquad ( 10 )$$

where N represents the number of input nodes of the attention operator. In Equation 10, each parameter d_{qk}, dᵥ, R may be replaced by its corresponding distribution parameter q from Equation 9, which would make the cost C a function of the combined distribution πq.

Notably, Equation 10 has no more than second order dependence in its parameters. That is, multiplying each of the parameters by a normalization constant x, the resulting cost function would be a quadratic function of x.

More generally, when expressing each parameter as a function of the raw pruning parameter πq in Equation 9, multiplication of each raw pruning parameter by some factor x may result in a quadratic function. In such a case, Equation 9 may be rewritten:

$${C}_{m} ( {π}_{q} , x ) = {a}_{m} ( {π}_{q} ) {x}^{2} + {b}_{m} ( {π}_{q} ) x + {c}_{m} ( {π}_{q} ) \qquad ( 11 )$$

Repeating for each module m, all quadratic, linear, and constant terms may be combined for the cost of the full network:

$$A ( {Π}_{q} ) = {\sum }_{m} {a}_{m} ( {π}_{q} )$$

$$B ( {Π}_{q} ) = {\sum }_{m} {b}_{m} ( {π}_{q} )$$

$$C ( {Π}_{q} ) = {\sum }_{m} {c}_{m} ( {π}_{q} )$$

$$C ( {Π}_{q} , x ) = A ( {Π}_{q} ) {x}^{2} + B ( {Π}_{q} ) x + c ( {Π}_{q} )$$

where Π_{q} represents all network pruning parameters. The network cost may be fixed at a budget value ß which now corresponds to setting x such that:

$$ß = C ( {Π}_{q} , x ) = A ( {Π}_{q} ) {x}^{2} + B ( {Π}_{q} ) x + C ( {Π}_{q} ) , e . g . , \qquad ( 12 )$$

$$A ( {Π}_{q} ) {x}^{2} + B ( {Π}_{q} ) x + C ( {Π}_{q} ) - ß = 0 \qquad ( 13 )$$

Because of the quadratic nature of the cost function, the normalization constant x may be computed as:

$$x = \frac{- B ( {Π}_{q} ) + \sqrt{{B ( {Π}_{q} )}^{2} - 4 A ( {Π}_{q} ) ( C ( {Π}_{q} ) - ß )}}{2 A ( {Π}_{q} )} \qquad ( 14 )$$

thus, expressing x as a function of Π_{q}.

Accordingly, by training using min(π_{q}x, 1) as the pruning parameters in each module, with x defined by Equation 14, the training may be directly in the regime where the budget cost is satisfied.

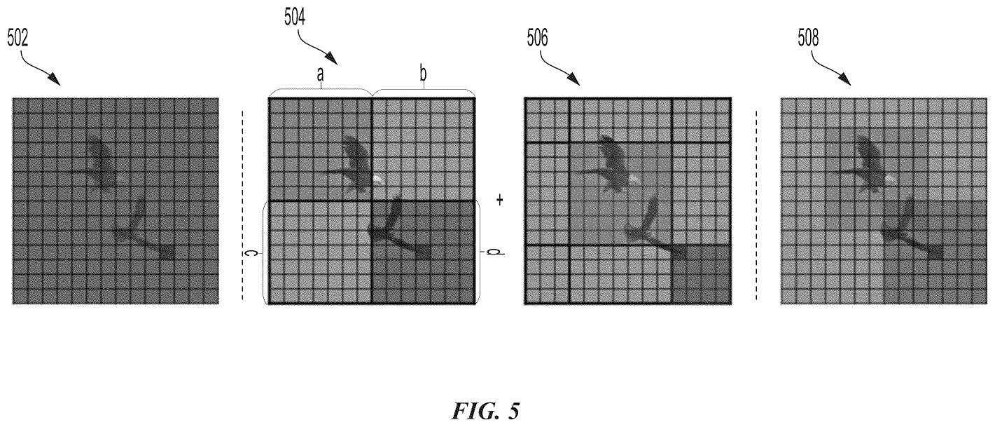

FIG. 5 is a diagram illustrating various examples of attention neighborhoods, in accordance with various aspects of the present disclosure. Referring to FIG. 5, the example attention neighborhoods may include (but are not limited to) a self-attention (502), a window self-attention (attention neighborhoods with equally sized windows) (504), shifted window self-attention (506), or neighborhood attention (508). Each example attention neighborhood may include one or more neighborhoods. The neighborhoods may have different sizes and/or a different number of channels. For instance, the example attention neighborhood 504 may include four attention neighborhoods (a-d). Each of the attention neighborhoods (a-d) may have a different number of channels. For instance, attention neighbor (a) may have 10 channels, attention neighborhood (b) may have 36 channels, attention neighborhood (c) may have 70 channels and attention neighborhood (d) may have 128 channels. Of course, the number of neighborhoods, the size of the neighborhood and the number of channels are merely examples for ease of understanding and not limiting.

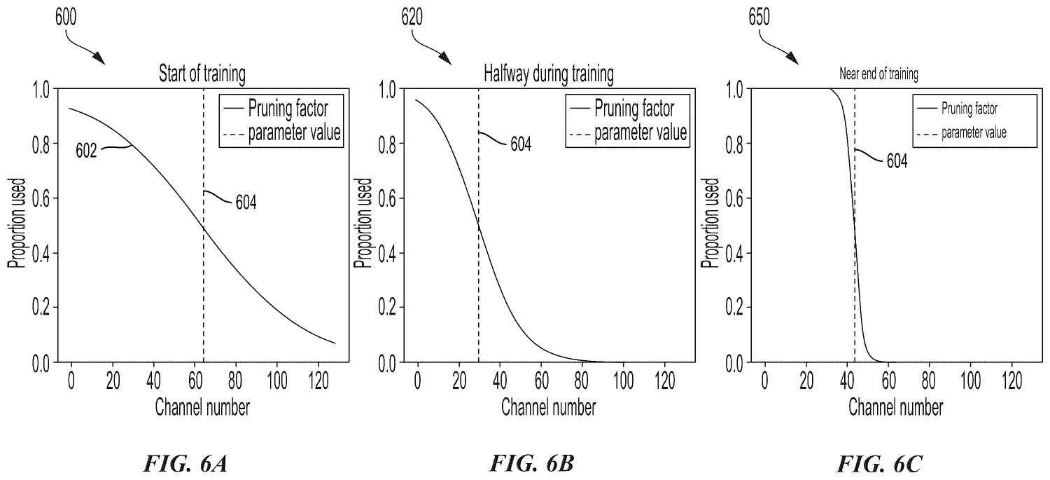

FIG. 6A-C are diagrams illustrating a training sequence for determining architecture parameters for attention heads, in accordance with various aspects of the present disclosure. Referring to FIG. 6A, the diagram 600 shows that at the start of training, attention heads may be initialized. In the diagram 600, a curve 602 indicates a proportion of channels used for a given number of channels. At the start of training, a target number of channels (indicated by line 604) may be set near a midpoint (e.g., where proportion of channels used is 0.5). The first 64 channels may be common among the different candidates for the number of channels within an attention head. Because the lower channels may be common (e.g., shared) to the different candidates, behavioral consistency may be maintained among the candidates.

Rather than applying a hard pruning, in which channels above the midpoint 604 are dropped, a soft pruning technique may be performed. The number of channels (or other architecture parameter) may then be constrained to lie in a given range [pmin, pmax].

In FIGS. 6B and 6C, the soft pruning technique may be applied halfway during training (e.g., 620) with annealing until a candidate (e.g., number of channels with the range) is selected at the end of training (e.g., 650), based on a total fixed training budget. As shown in FIG. 6B, the range for the number of channels may be reduced from [1, 128] to [1, 64] in accordance with a temperature parameter T. The temperature parameter T may be decreased over the training such that the temperature approaches zero near the end of training. The target number of channels (indicated by line 604) may be shifted to 30 channels based on a pruning factor as described in Equation 9, for instance. The pruning factor may be normalized according to a fixed training budget. In some aspects, the fixed training budget may correspond to the computation complexity for the attention operations, for example.

In FIG. 6C, near the end of the training sequence, the range may be further reduced according to the temperature parameter T. The target number of channel (indicated by line 604) may be determined as the selected architecture parameter among the candidates (e.g., number of channels within the range) is determined. Accordingly, during inference, a corresponding attention head may use 42 channels for the attention computation.

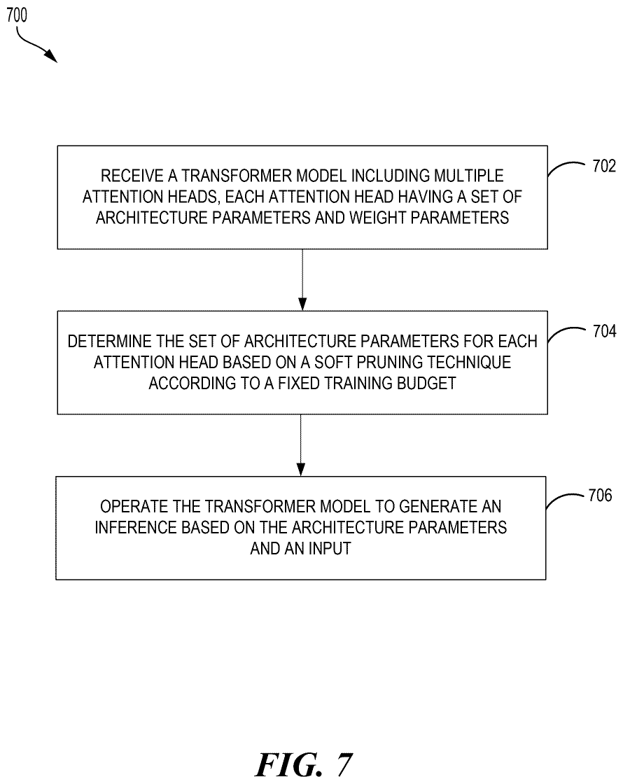

FIG. 7 is a flow diagram illustrating a processor-implemented method 700 for configuring attention mechanisms of transformer models using soft masking and soft channel pruning, in accordance with various aspects of the present disclosure. The processor-implemented method 700 may be performed by one or more processors such as the CPU (e.g., 102, 422), GPU (e.g., 104, 426), and/or other processing unit (e.g., DSP 424, NPU 428), for example.

At block 702, the one or more processors receive a transformer model including multiple attention heads, each attention head having a set of architecture parameters and weight parameters. For example, as described, an artificial neural network may be received. The artificial neural network (ANN) may for instance comprise a transformer model (e.g., 302 of FIG. 3B). The transformer model may include multiple attention heads (e.g., 322). Each attention head of the multi-head attention can look at a different neighborhood size or may have architecture parameters that vary in comparison to other attention heads.

At block 704, the one or more processors determine the set of architecture parameters for each attention head based on a soft pruning technique according to a fixed training budget. For instance, as described, during training, soft pruning may be applied. In soft pruning, channels may be removed only partially by multiplication with a factor in the range [0, 1]. The soft pruning approach may, for example be implemented by framing the problem as a Mixture-of-Experts situation, in which the expert distribution may be learned. A budget ß, representing the total computational cost of the network in giga multiply accumulate operations per second (GMACS) may be employed. As the loss regularization approach may be difficult to optimize, a budget may be such that each πq is multiplied by a normalization constant x, such that the resulting budget is fixed during training.

At block 706, the one or more operate the transformer model to generate an inference based on the architecture parameters and an input. Having trained the transformer model to determine the architecture parameters, the transformer model may be operated to generate an inference (e.g., a classification, object detection, or a following token).

### Example Aspects

Aspect 1: An apparatus comprising: at least one memory; and at least one processor coupled to the at least one memory, the at least one processor configured to: receive a transformer model including multiple attention heads, each attention head having a set of architecture parameters and weight parameters; determine the set of architecture parameters for each attention head based on a soft pruning technique according to a fixed training budget; and operate the transformer model to generate an inference based on the architecture parameters and an input.

Aspect 2: The apparatus of Aspect 1, in which the at least one processor is further configured to fine tune the weight parameters of the transformer model.

Aspect 3: The apparatus of Aspect 1 or 2, in which each of the multiple attention heads has a different number of neighborhoods with different neighborhood sizes.

Aspect 4: The apparatus of any preceding Aspect, in which the fixed training budget corresponds to a network cost associated with performing corresponding attention operations.

Aspect 5: The apparatus of any preceding Aspect, in which the at least one processor is further configured to initialize the set of architecture parameters according to maximal sizes for each of the architecture parameters.

Aspect 6: The apparatus of any preceding Aspect, in which the at least one processor is further configured to: define a set of candidate architecture parameters; and apply an annealing process according to the fixed training budget to select a candidate architecture parameter from the set of candidate architecture parameters.

Aspect 7: The apparatus of any preceding Aspect, in which the at least one processor is further configured to apply a mask to at least one neighborhood of the multiple attention heads according to a mask factor.

Aspect 8: A processor-implemented method performed by one or more processor, the processor-implemented method comprising: receiving a transformer model including multiple attention heads, each attention head having a set of architecture parameters and weight parameters; determining the set of architecture parameters for each attention head based on a soft pruning technique according to a fixed training budget; and operating the transformer model to generate an inference based on the architecture parameters and an input.

Aspect 9: The processor-implemented method of Aspect 8, further comprising fine-tuning the weight parameters of the transformer model.

Aspect 10: The processor-implemented method of Aspect 8 or 9, in which each of the multiple attention heads has a different number of neighborhoods with different neighborhood sizes.

Aspect 11: The processor-implemented method of any of Aspects 8-10, in which the fixed training budget corresponds to a network cost associated with performing corresponding attention operations.

Aspect 12: The processor-implemented method of any of Aspects 8-11, further comprising initializing the set of architecture parameters according to maximal sizes for each of the architecture parameters.

Aspect 13: The processor-implemented method of any of Aspects 8-12, further comprising: defining a set of candidate architecture parameters; and applying an annealing process according to the fixed training budget to select a candidate architecture parameter from the set of candidate architecture parameters.

Aspect 14: The processor-implemented method of any of Aspects 8-14, further comprising to apply a mask to at least one neighborhood of the multiple attention heads according to a mask factor.

Aspect 15: An apparatus comprising: means for receiving a transformer model including multiple attention heads, each attention head having a set of architecture parameters and weight parameters; means for determining the set of architecture parameters for each attention head based on a soft pruning technique according to a fixed training budget; and means for operating the transformer model to generate an inference based on the architecture parameters and an input.

Aspect 16: The apparatus of Aspect 15, further comprising means for fine-tuning the weight parameters of the transformer model.

Aspect 17: The apparatus of Aspect 15 or 16, in which each of the multiple attention heads has a different number of neighborhoods with different neighborhood sizes.

Aspect 18: The apparatus of any of Aspects 15-17, in which the fixed training budget corresponds to a network cost associated with performing corresponding attention operations.

Aspect 19: The apparatus of any of Aspects 15-18, further comprising means for initializing the set of architecture parameters according to maximal sizes for each of the architecture parameters.

Aspect 20: The apparatus of any of Aspects 15-20, further comprising: means for defining a set of candidate architecture parameters; and means for applying an annealing process according to the fixed training budget to select a candidate architecture parameter from the set of candidate architecture parameters.

In one aspect, the receiving means, determining means, operating means defining means and/or applying means may be the CPU (102,422), the GPU (104, 426) program memory associated with the CPU (102,422) or the GPU (104, 426), the NPU 108, the dedicated memory block 118, the fully connected layers 362, the NPU 428 and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus comprising:
at least one memory; and
at least one processor coupled to the at least one memory, the at least one processor configured to:
receive a transformer model including multiple attention heads, each attention head having a set of architecture parameters and weight parameters;
determine the set of architecture parameters for each attention head based on a soft pruning technique according to a fixed training budget; and
operate the transformer model to generate an inference based on the architecture parameters and an input.

2. The apparatus of claim 1, in which the at least one processor is further configured to fine tune the weight parameters of the transformer model.

3. The apparatus of claim 1, in which each of the multiple attention heads has a different number of neighborhoods with different neighborhood sizes.

4. The apparatus of claim 1, in which the fixed training budget corresponds to a network cost associated with performing corresponding attention operations.

5. The apparatus of claim 1, in which the at least one processor is further configured to initialize the set of architecture parameters according to maximal sizes for each of the architecture parameters.

6. The apparatus of claim 1, in which the at least one processor is further configured to:
define a set of candidate architecture parameters; and
apply an annealing process according to the fixed training budget to select a candidate architecture parameter from the set of candidate architecture parameters.

7. The apparatus of claim 1, in which the at least one processor is further configured to apply a mask to at least one neighborhood of the multiple attention heads according to a mask factor.

8. A processor-implemented method performed by one or more processor, the processor-implemented method comprising:
receiving a transformer model including multiple attention heads, each attention head having a set of architecture parameters and weight parameters;
determining the set of architecture parameters for each attention head based on a soft pruning technique according to a fixed training budget; and
operating the transformer model to generate an inference based on the architecture parameters and an input.

9. The processor-implemented method of claim 8, further comprising fine-tuning the weight parameters of the transformer model.

10. The processor-implemented method of claim 8, in which each of the multiple attention heads has a different number of neighborhoods with different neighborhood sizes.

11. The processor-implemented method of claim 8, in which the fixed training budget corresponds to a network cost associated with performing corresponding attention operations.

12. The processor-implemented method of claim 8, further comprising initializing the set of architecture parameters according to maximal sizes for each of the architecture parameters.

13. The processor-implemented method of claim 8, further comprising:
defining a set of candidate architecture parameters; and
applying an annealing process according to the fixed training budget to select a candidate architecture parameter from the set of candidate architecture parameters.

14. The processor-implemented method of claim 8, further comprising to apply a mask to at least one neighborhood of the multiple attention heads according to a mask factor.

15. An apparatus comprising:
means for receiving a transformer model including multiple attention heads, each attention head having a set of architecture parameters and weight parameters;
means for determining the set of architecture parameters for each attention head based on a soft pruning technique according to a fixed training budget; and
means for operating the transformer model to generate an inference based on the architecture parameters and an input.

16. The apparatus of claim 15, further comprising means for fine-tuning the weight parameters of the transformer model.

17. The apparatus of claim 15, in which each of the multiple attention heads has a different number of neighborhoods with different neighborhood sizes.

18. The apparatus of claim 15, in which the fixed training budget corresponds to a network cost associated with performing corresponding attention operations.

19. The apparatus of claim 15, further comprising means for initializing the set of architecture parameters according to maximal sizes for each of the architecture parameters.

20. The apparatus of claim 15, further comprising:
means for defining a set of candidate architecture parameters; and
means for applying an annealing process according to the fixed training budget to select a candidate architecture parameter from the set of candidate architecture parameters.
